(19) United States
(12) Patent Application Publication
(10) Pub. No.: US 2013/0218790 A1
(43) Pub. Date: Aug. 22, 2013

(54) Traceability, Corrective Action, and Certification Processes for Constructed Welding Material Packages

(71) Applicants: CHRISTOPHER DAVID AGOSTI, SOUTH EUCLID, OH (US); WILLIAM DIMMETT COOPER, CHARDON, OH (US); VAIDYANATH BHARATA RAJAN, MENTOR, OH (US)

(72) Inventors: CHRISTOPHER DAVID AGOSTI, SOUTH EUCLID, OH (US); WILLIAM DIMMETT COOPER, CHARDON, OH (US); VAIDYANATH BHARATA RAJAN, MENTOR, OH (US)

(73) Assignee: LINCOLN GLOBAL, INC., CITY OF INDUSTRY, CA (US)

(21) Appl. No.: 13/852,484

(22) Filed: Mar. 28, 2013

Related U.S. Application Data
(63) Continuation of application No. 12/913,299, filed on Oct. 27, 2010.

(51) Int. Cl. G06Q 10/08

(52) U.S. Cl. CPC G06Q 10/083
USPC 705/317

(57) ABSTRACT

Systems and methods of testing and certifying a package for transport to a customer and use by a customer, and of correcting packaging failures due to transport and use in the field. A package such as, for example, a bulk composite constructed package for shipping welding material product, is tested according to a selected testing protocol. The test results are analyzed and packaging attributes of the package are transformed based on the analyzed test results if the tested package fails any aspect of the testing protocol. Packaging attributes that may be transformed include packaging component design, packaging markings, packaging handling instructions, packaging component manufacturing procedures, packaging component testing procedures, and packaging assembly procedures. Once the package passes all aspects of the testing protocol, customer certification documentation is generated.

### CROSS-REFERENCE TO RELATED APPLICATIONS

This application is a continuation of U.S. patent application Ser. No. 12/913,299, filed Oct. 27, 2010, the disclosure of which is incorporated herein by reference.

### TECHNICAL FIELD

Certain embodiments relate to packaging. More particularly, certain embodiments relate to methods of testing and certifying a package for transport and use by a customer, and methods of correcting packaging failures due to transport and use in the field.

### BACKGROUND

In North America, there is a growing need for increased accountability and verification of product capabilities. Within the manufacturing sector, the welding industry is becoming especially cognizant of this need and customers are beginning to demand verification and assurance that a product will survive transport and handling prior to using the product. Welding consumable packages and products are vulnerable to failure or damage during transport and handling if the associated packaging is not sufficient. A welding consumable product may include a coiled welding wire or stick electrodes, for example. Such welding consumable products may be packaged for transport and use in various ways, depending on the size, weight, and other factors associated with the welding consumables. FIG. 1 illustrates an example collection of various types of welding consumable packages.

Further limitations and disadvantages of conventional, traditional, and proposed approaches will become apparent to one of skill in the art, through comparison of such approaches with embodiments of the present invention as set forth in the remainder of the present application with reference to the drawings.

### BRIEF SUMMARY

Embodiments of the present invention comprise a method of testing and certifying a package for transport to a customer and use by a customer, and a method of correcting packaging failures due to transport and use in the field. A package such as, for example, a bulk composite constructed package for shipping welding material, is tested according to a selected testing protocol. The test results are analyzed and packaging attributes of the package are transformed based on the analyzed test results if the tested package fails any aspect of the testing protocol. Packaging attributes that may be transformed include packaging component design, packaging markings, packaging handling instructions, packaging component manufacturing procedures, packaging component testing procedures, and packaging assembly procedures. Once the package passes all aspects of the testing protocol, customer certification documentation is generated. In general, new package designs or types and modified or updated package designs or types are to be tested and certified, in accordance with various embodiments of the present invention.

These and other features of the claimed invention, as well as details of illustrated embodiments thereof, will be more fully understood from the following description and drawings.

### BRIEF DESCRIPTION OF THE DRAWINGS

FIG. 1 illustrates an example collection of various types of welding consumable packages;

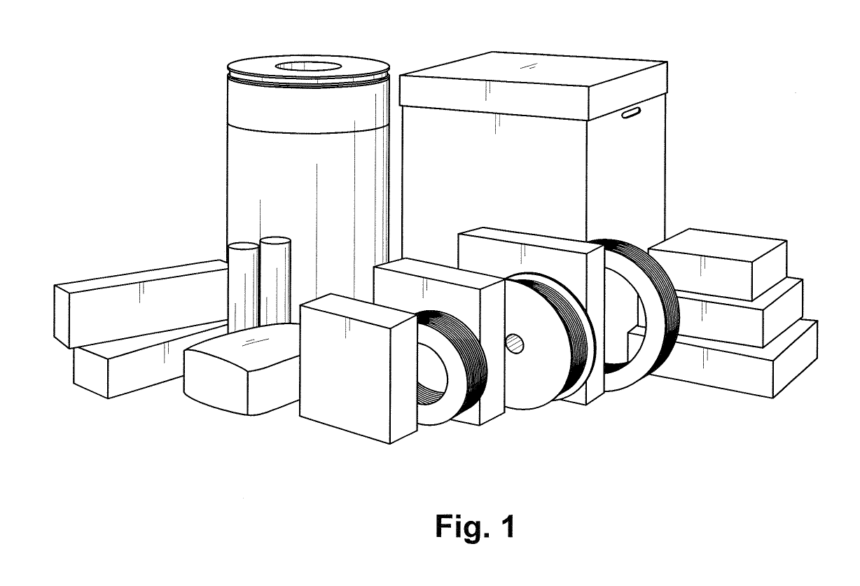

FIG. 2 is a block diagram illustrating the relationships between various packaging-related entities, in accordance with an embodiment of the present invention;

FIG. 3 is a flowchart of an example embodiment of a method of testing and certifying a package for transport to a customer entity and for handling and use by the customer entity;

FIG. 4 is a flowchart of an example embodiment of a method of correcting packaging failures due to transport and use in the field;

FIG. 5 illustrates several examples of welding consumable box-type and crate-type packages;

FIG. 6 illustrates several examples of welding consumable drum-type and can-type packages;

FIG. 7 illustrates several examples of welding consumable reel-type packages showing the reeled consumable welding wire therewith;

FIG. 8 illustrates an example of a welding consumable pail-type package and an example of a welding consumable stem-type package, each showing the consumable welding wire therewith;

FIG. 9 illustrates an example of how a drum-type package may be lifted, for example, at a customer facility;

FIG. 10 illustrates a set of instructions that may be printed on a crate-type package, showing how the crate-type package is to be mounted and set up for use at a customer facility; and

FIG. 11 illustrates an embodiment of system components for capturing and analyzing test results, simulating the transformation of packaging attributes, and generating certification documentation.

### DETAILED DESCRIPTION

The terms “package” and “packaging” are used generally and broadly herein. However, in much of the description herein, the term “packaging” refers to the container, reel, or stem before it is filled or wound with a consumable welding material, and the term “package” refers to the packaging filled or wound with the consumable welding material. Even though much of the description herein is in the context of packages and packaging for welding materials, the claimed subject matter of the present invention is not intended to be limited to such, but should be broadly interpreted as referring to packages and packaging for shipping and transporting any type of product or material. Furthermore, the terms “package” and “packaging” may refer to a unitized package (i.e., a single package) or a non-unitized package (i.e., multiple packages that are stacked and/or strapped together) as used herein.

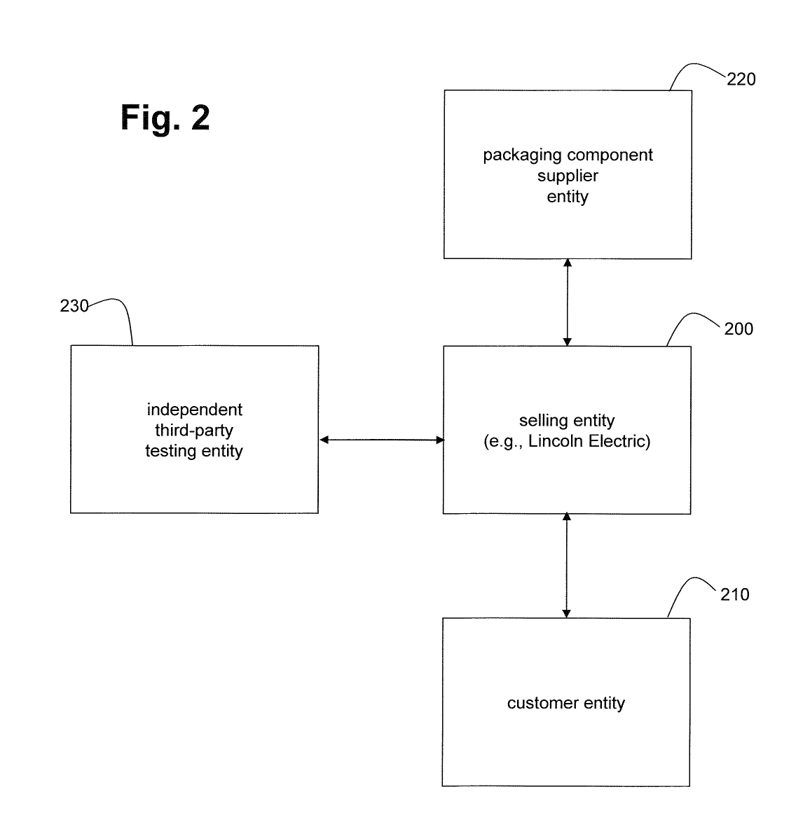

FIG. 2 is a block diagram illustrating the relationships between various packaging-related entities, in accordance with an embodiment of the present invention. At the center of the relationships is the primary selling entity 200. In accordance with an embodiment of the present invention, the primary selling entity 200 manufactures welding materials (e.g., bulk welding wire and stick electrodes), packages the welding materials, and ships the packaged welding materials to customers, for example, a customer entity 210. Packaging the welding materials involves incorporating the welding materials into the packaging, and may also involve first assembling packaging components to form the packaging. The customer entity 210 receives, handles, and uses the welding materials at the customer location. As is discussed later herein, the selling entity 200 and the customer entity 210 interact and communicate with each other to ensure that various aspects of welding material packaging are certified and to address any package-related problems that may arise, in accordance with an embodiment of the present invention. The selling entity may also be involved in risk assessment. The risk assessment process may help determine which packaging components are critical, help determine additional testing to be performed, help interpret test results, and help influence the ultimate transformation of packaging attributes.

Other packaging-related entities include supplier entities such as, for example, a packaging component supplier entity 220 as shown in FIG. 2. The packaging component supplier entity 220 manufactures the various packaging components that make up the packaging, and supplies those packaging components to the selling entity 200, either in assembled or unassembled form. When packaging components are provided to the selling entity 200 by a supplier entity 220 in unassembled form, then the selling entity 200 assembles the packaging components to create the assembled packaging, in accordance with an embodiment of the present invention.

Also, in accordance with an embodiment of the present invention, the selling entity 200 tracks packaging components from the supplier entity 220 through the selling entity 200 and to the customer entity 210, thereby providing both upstream and downstream traceability of packaging components. The selling entity 200 keeps track of which specific packages that specific supplier packaging components went into and to which customer entities the packages were shipped, in accordance with an embodiment of the present invention. The selling entity uses a computerized auditing system, in accordance with an embodiment of the present invention, to track and trace packaging components. The selling entity 200 may require the supplier entity 220 to mark (e.g., with an identifier) and track each manufactured packaging component within its facility and provide information related to when the packaging component was manufactured (e.g., a date) and the manufacturing batch to which the packaging component belongs.

Furthermore, the selling entity 200 may require the supplier entity 220 to test and document individual types of packaging components that are deemed by the selling entity 200 to be critical packaging components, and provide test information to the selling entity 200. This may include the supplier entity 220 performing a statistical capability analysis. As is discussed later herein, the selling entity 200 and the supplier entity 220 interact and communicate with each other to ensure that various aspects of welding material packaging components are acceptable and to address any packaging component-related problems that may arise, in accordance with an embodiment of the present invention.

Another packaging-related entity, as shown in FIG. 2, is an independent third-party testing entity 230. In accordance with an embodiment of the present invention, the selling entity 200 provides at least one fully assembled package that is filled with welding material to the testing entity 230. The independent testing entity 230 proceeds to test the package, being representative of a particular package type, according to a testing protocol, as dictated by the selling entity 200, and which has been approved by the customer entity 210. The testing protocol is designed to ensure that the package will survive transport to the customer entity 210 and handling and use by the customer entity 210. Passing all aspects of the testing protocol allows the selling entity 200 to certify the package to the customer entity 210. As is discussed later herein, the selling entity 200 and the independent third-party testing entity 230 interact and communicate with each other to ensure that testing proceeds as agreed to, and to address any testing-related problems that may arise, in accordance with an embodiment of the present invention.

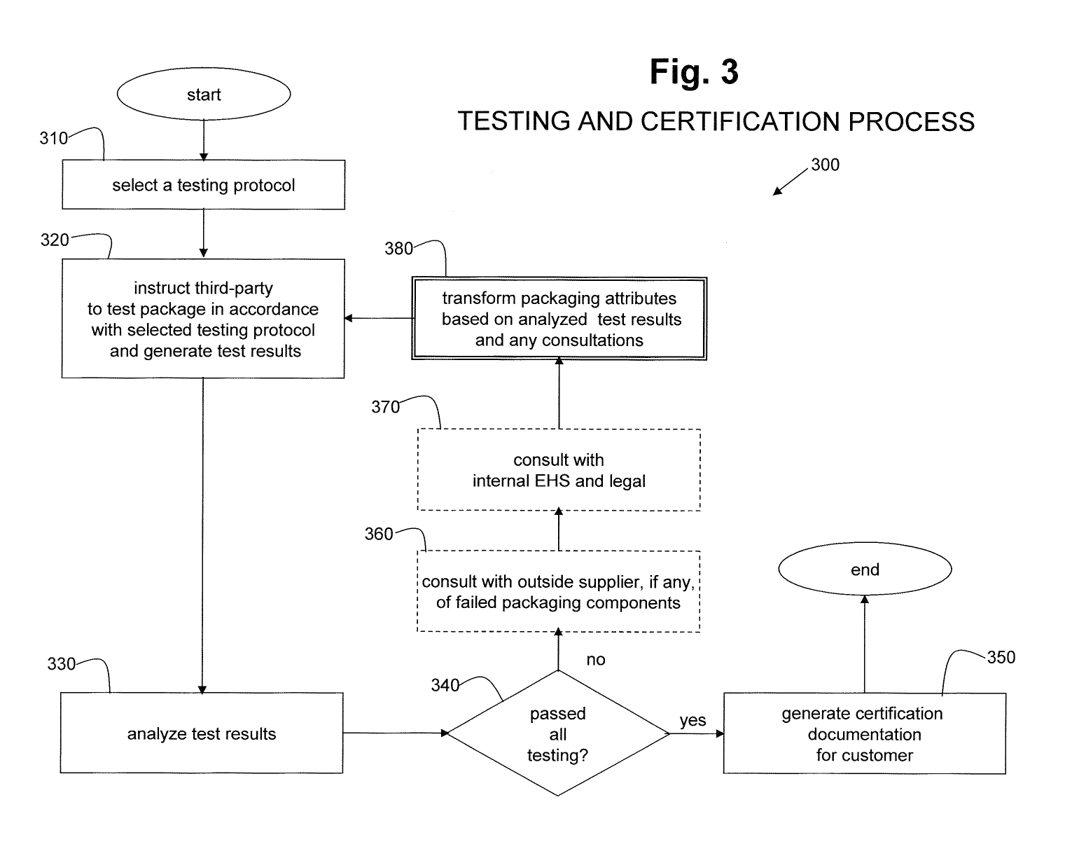

FIG. 3 is a flowchart of an example embodiment of a method 300 of testing and certifying a package for transport to a customer entity 210 and for handling and use by the customer entity 210. In step 310, a testing protocol is selected by the selling entity 200. The testing protocol may be an industrial testing standard such as, for example, ASTM D4169 “Standard Practice for Performance Testing of Shipping Containers and Systems”, or some portion thereof The testing protocol may, instead, be a modification of an industrial testing standard, in accordance with an embodiment of the present invention. Alternatively, the testing protocol may be a custom testing protocol defined by, for example, the selling entity 200 with input from the independent third-party testing entity, and approved by the customer entity 210. This may also involve input provided directly by the customer entity 210. For example, certain large customers may purchase products with “special” features or customized requirements. As such, the selling entity 200 and the customer entity 210 agree upon a specific purchase specification or agreement where such a specification may require additional testing or different testing methods beyond those defined either solely by the selling entity 200 or by a particular industrial standard. In accordance with an embodiment of the present invention, internal safety department personnel (e.g., internal environmental health and safety (EHS) personnel) and/or internal legal personnel at the selling entity 200 may be consulted as part of the testing protocol selecting step to help protect customer personnel of the customer entity 210 and testing personnel of the testing entity 230 from a safety standpoint, and to help protect the selling entity 200 from a legal standpoint.

In step 320, the selling entity 200 instructs the independent third-party testing entity 230 to test at least one package, having packaging attributes and being representative of a particular packaging type, in accordance with the selected testing protocol and to generate corresponding test results. In accordance with an embodiment of the present invention, the packaging attributes may include packaging component design (including packaging component materials used and structural and ornamental design aspects), packaging markings, packaging handling instructions, packaging component manufacturing procedures, packaging component testing procedures, and packaging assembly procedures. These packaging attributes may originate with the selling entity 200 and/or with the packaging component supplier entity 220. However, all packaging attributes are ultimately approved by the selling entity 200, and the selling entity 200 is held responsible for all packaging attributes by the customer entity 210.

In step 330, the test results generated by the third-party testing entity 230 are analyzed by the selling entity 200. In accordance with an embodiment of the present invention, the test results are analyzed by the selling entity 200 in coordination with the third-party testing entity 230. Analysis of the test results may include inspecting a package after a particular test, for example. Analysis of the test results in step 330 allows the selling entity 200 to understand which aspects of the testing protocol were passed and/or failed by the package under test, and which packaging components were involved in any failed aspects of the testing protocol.

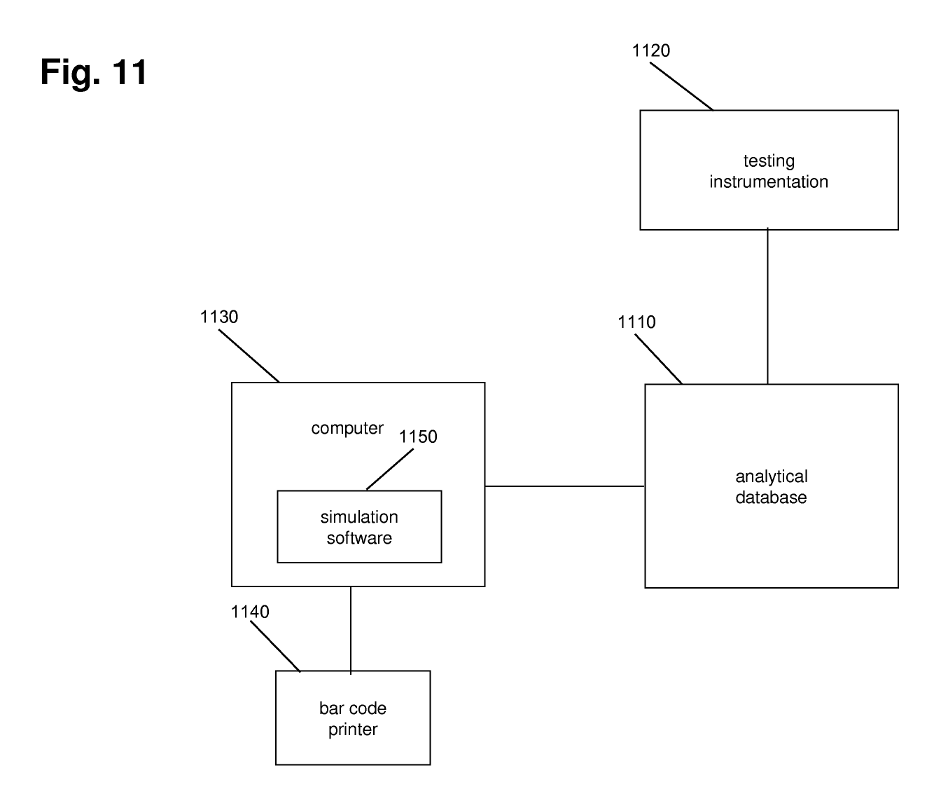

In accordance with an embodiment of the present invention, the analyzing step 330 is performed using an analytical database 1110 (see FIG. 11) storing the test results. The analytical database 1110 is designed to assist in decision-making and may contain statistical information related to the test results, for example. In accordance with an embodiment of the present invention, the analytical database 1110 includes software running on a computer hardware platform. The analytical database 1110 may interface to testing instrumentation 1120 (see FIG. 11), for example, to capture test results as they become available during testing of a package.

In step 340, if all aspects of the testing protocol were passed, then the selling entity 200 proceeds to generate certification documentation for the customer in step 350. The certification documentation serves as proof to the customer entity 210 that packages of a particular package type will survive transport to and handling and use by the customer entity 210. The certification documentation may include, for example, an indicator or a sticker to be attached to the outside of the package indicating that it has been tested according to the selected test protocol and passed all testing, in accordance with an embodiment of the present invention. For example, the step 350 of generating customer certification documentation may include generating and/or printing a bar code using a computer 1130 (see FIG. 11) interfacing to a bar code printer 1140 and an analytical database 1110 storing the test results, where the bar code is capable of being affixed to a package (e.g., a printed sticker). A customer entity may read the bar code affixed to the package using a bar code reader to verify the certification status of the package type and/or to automatically enter the certification information into a customer database. Alternatively, a simple alpha-numeric code may be used.

The certification documentation may further include formalized test results that are provided to the customer entity 210 and which are also kept on file at the selling entity 200. Certification documentation may also include the validating and/or witnessing signature of an authorized representative of any of the selling entity 200, the third-party testing entity 230, and the supplier entity 220. The certification documentation for a particular package type may also be put on a website provided by the selling entity 200 such that a customer entity 210, or a potential customer entity 210, may access the certification documentation online.

Other documentation such as, for example, reports and package handling instructions, are also provided to the customer entity 210 and may be kept on file at the selling entity 200 and/or put on a website provided by the selling entity 200, in accordance with various embodiments of the present invention. Furthermore, artwork and label changes, purchase specification adjustments, in-package instruction document updates, and sale brochure updates may be made as a result of the testing and certification method 300.

In step 340, if all aspects of the testing protocol were not passed, then in step 360, the selling entity 200 proceeds to consult with the packaging component supplier entity 220 associated with any failed packaging components, and/or, in step 370, with internal EHS and legal of the selling entity 200, based on the analyzed test results. Step 360 and/or step 370 may be optional, however, in accordance with various embodiments of the present invention.

In step 380, the selling entity 200 causes at least one of the packaging attributes of the failed package to be transformed based on the analyzing step 330 and based on any consultations with the supplier entity 220, internal EHS, or internal legal. For example, the selling entity 200 may instruct the supplier entity 220 of a failed packaging component to re-design or modify the failed packaging component in a particular way which the selling entity 200 believes will allow the package to ultimately pass all aspects of the testing protocol. This may involve, for example, changing a packaging component material or changing the corrugation design of a packaging component. Many other design aspects that could be changed may be possible as well.

In accordance with an embodiment of the present invention, the transforming step 380 is performed, at least in part, using simulation software 1150 running on a computer 1130 (see FIG. 11). The simulation software 1150 may enable a user to simulate changing the packaging component design, the packaging assembly procedures, the packaging component manufacturing procedures, the packaging handling procedures, the packaging component testing procedures, and/or the packaging marking procedures before actually making those changes in the real world. For example, a simulation of a packaging component manufacturing procedure could be changed based on the analyzed test results and provide a strong indication that the change in the manufacturing procedure will solve the problem of damage occurring to the component during manufacturing. In accordance with an embodiment of the present invention, the simulation software 1150 may be a computer-aided design (CAD) software package, for example.

As another example of causing at least one of the packaging attributes of the failed package to be transformed, the selling entity 200 may modify its procedure for assembling the various packaging components of the packaging. For example, during the analyzing step 330, it may have been found that the assembly process used by the selling entity 200 was causing damage to a particular packaging component. As still another example, of causing at least one of the packaging attributes of the failed package to be transformed, the selling entity 200 may direct the supplier entity 220 to modify its in-house packaging component testing procedure. For example, during the analyzing step 330, the selling entity 200 may have discovered that a particular packaging component provided by the supplier entity 220 was not withstanding particular shear forces experienced by the packaging component during testing at the third-party testing entity 230, and that the current shear force test performed by the supplier entity is not adequate.

As another example of causing at least one of the packaging attributes of the failed package to be transformed, the selling entity 200 may change the packaging handling procedures and instructions for the package. For example, during testing at the third-party testing entity 230, the package may have become damaged as a result of being handled by third-party testing entity personnel, even though the package was handled according to the current handling instructions. As a result, the damage caused by the handling of the package resulted in the package failing one of the tests of the testing protocol.

As still a further example of causing at least one of the packaging attributes of the failed package to be transformed, the selling entity 200 may direct the supplier entity 220 to modify its packaging component manufacturing procedure. For example, during testing at the third-party testing entity 230, one packaging component of four identical packaging components may have failed. During the analyzing step 330, the selling entity 200 determined that the failed packaging component was not manufactured properly (e.g., has a manufacturing defect) even though the other three supposedly identical packaging components were manufactured properly. This indicates that the supplier entity has an unreliable manufacturing procedure which needs to be fixed.

As still another example of causing at least one of the packaging attributes of the failed package to be transformed, the selling entity 200 may modify the packaging markings on the package. For example, the current packaging markings may indicate that the package is to be placed in a particular orientation when being lifted. However, during a lifting test of the testing protocol at the third-party testing entity 230, the package failed. The selling entity 200 determined during the analyzing step 330 that re-orienting the package during lifting should eliminate the problem.

After at least one of the packaging attributes has been transformed in step 380, the method 300 reverts back to step 320 where a new package, having the transformed attribute(s), is tested in accordance with the selected testing protocol by the independent third-party testing entity 230. The method 300 continues until, in step 340, it is determined that the package has passed all aspects of the testing protocol and, then, in step 350 the certification documentation is generated for the customer entity 210. Several iterations of transforming packaging attributes may have to be performed before a particular package type passes all testing and can be certified.

In accordance with an embodiment of the present invention, the selling entity 200 may elect to (or be directed by a customer entity 210 to) perform additional testing at the selling entity's facility, above and beyond the testing protocol used for testing at the independent third-party testing entity 230, before final certification can be established.

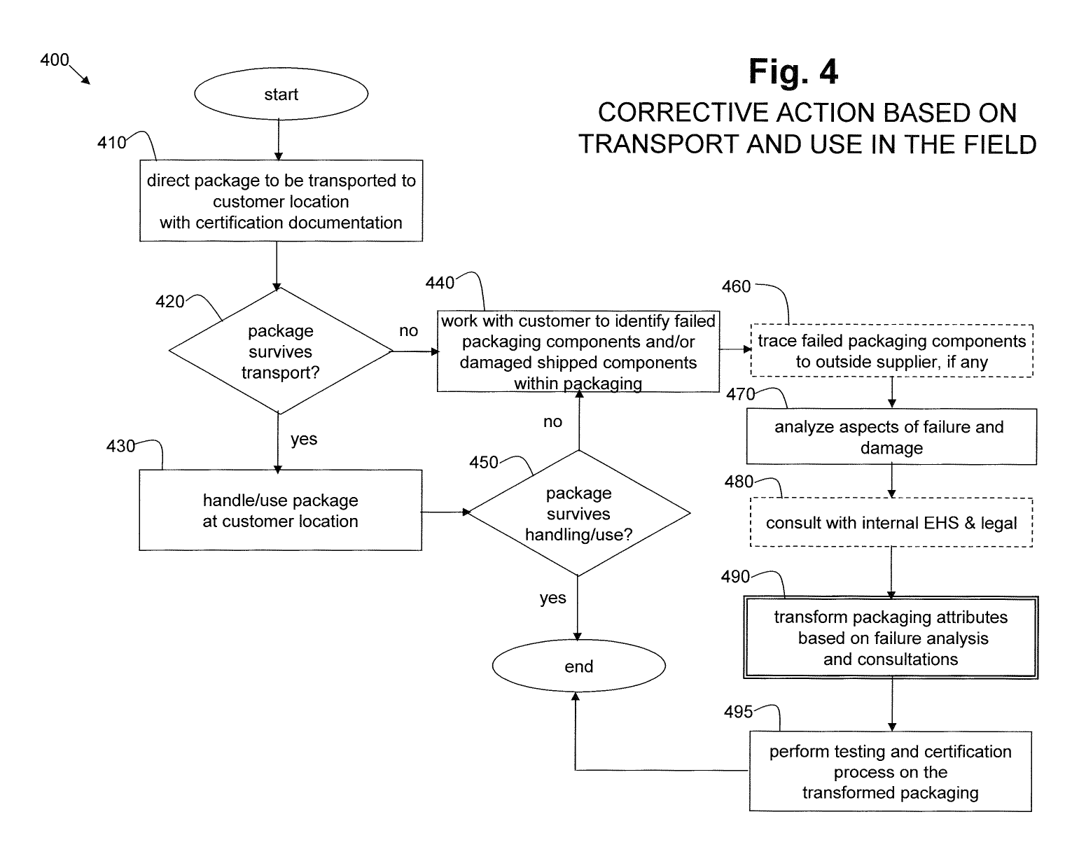

FIG. 4 is a flowchart of an example embodiment of a method 400 of correcting packaging failures due to transport and use in the field. In step 410, the selling entity 200 directs that a package be transported to a customer entity 210 at a customer location with certification documentation. Transportation of the package may be via rail, ship, motor freight (e.g., truck), or air, for example. Other forms of transportation may be possible as well.

The transported package includes assembled packaging components containing at least one shipped component (e.g., a coil of bulk welding wire), in accordance with an embodiment of the present invention, and the package may be unitized or non-unitized. Again, the certification documentation serves as proof to the customer entity 210 that packages of a particular package type will survive transport to and handling and use by the customer entity 210. In step 420, if the package has survived transport to the customer entity 210, then the package is accepted by the customer entity 210 and, in step 430, the customer entity 210 proceeds to handle and use the package at the customer location.

However, in step 420, if the package does not survive transport to the customer entity 210, then in step 440, the selling entity 200 works with the customer entity 210 to identify any failed packaging components and/or damaged components (e.g., welding materials) that were shipped within the packaging. Similarly, in step 450, if the package does not survive handling and use by the customer entity 210, then in step 440, the selling entity 200 works with the customer entity 210 to identify any failed packaging components and/or damaged components (e.g., welding materials) that were shipped within the packaging.

In step 460, the selling entity 200 traces any failed packaging components back to the supplier entity 220 that supplied the components, if any. Again, the selling entity 200 may require the supplier entity 220 to mark (with an identifier) and track each manufactured packaging component within its facility and provide information related to when the packaging component was manufactured (e.g., a date), the manufacturing batch to which the packaging component belongs, and physical and/or material property test results from quality checks performed by the supplier entity 220. Furthermore, the selling entity 200 may require the supplier entity 220 to test and document individual types of packaging components that are deemed by the selling entity 200 to be critical packaging components, and provide the test information to the selling entity 200. In accordance with an embodiment of the present invention, step 460 may be optional.

In step 470, the selling entity 200 analyzes aspects of the failure and damage to the packaging and/or the shipped welding materials. The analyzing step 470 may be performed in coordination with the supplier entity 220 and/or the customer entity 210, in accordance with various embodiments of the present invention. In step 480 the selling entity 200 consults with internal EHS and/or internal legal based on the results of the analyzing step 470. In accordance with an embodiment of the present invention, step 480 may be optional. Examples of problems that may arise during transport or handling include that of a package being damaged such that it cannot be lifted, a package being damaged such that the welding wire will not pay out correctly during use, and a compromised environmental barrier resulting in moisture damage to the consumable welding product. Other problems are possible as well.

In step 490, the selling entity 200 causes at least one of the packaging attributes of the failed package to be transformed based on the analyzing step 470 and based on any consultations with the supplier entity 220, the customer entity 210, internal EHS, or internal legal. Again, the packaging attributes that may be transformed include packaging component design, packaging markings, packaging handling instructions, packaging component manufacturing procedures, packaging component testing procedures, and packaging assembly procedures.

In accordance with an embodiment of the present invention, the transforming step 490 is performed, at least in part, using simulation software 1150 running on a computer 1130 (see FIG. 11). The simulation software 1150 may enable a user to simulate changing the packaging component design, the packaging assembly procedures, the packaging component manufacturing procedures, the packaging handling procedures, the packaging component testing procedures, and/or the packaging marking procedures before actually making those changes in the real world. For example, a simulation of a packaging assembly procedure could be changed based on the analyzed test results and provide a strong indication that the change in the assembly procedure will solve the problem of damage occurring to the packaging during assembly.

For example, during the analyzing step 470, it may have been determined that an environmental barrier (e.g., a moisture barrier) within the package failed during transport, causing the welding wire inside the packaging to begin to oxidize (i.e., rust) due to exposure to moisture. In step 490, the design of the environmental barrier is transformed (e.g., the environmental barrier is made thicker) in an attempt to prevent future failures during transport.

In step 495, the selling entity 200 directs that a testing and certification process (e.g., the method 300 herein) be performed on the transformed packaging. The method 300 includes its own transforming step 380 as previously described herein. Again, several iterations of transforming packaging attributes may have to be performed before a particular package type passes all testing and can be re-certified.

In accordance with an embodiment of the present invention, the method 400 may also include isolating or quarantining other packages currently in use or awaiting use by the customer entity 210 which are determined to be suspect due to field performance of other packages from the same batch, or identification of a suspect batch via internal quality testing.

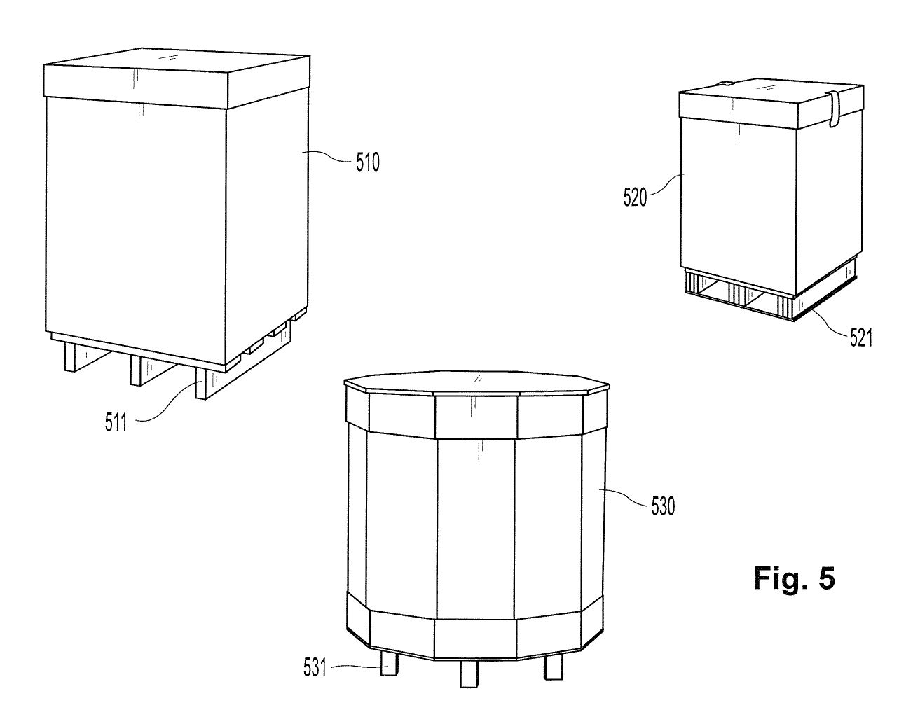

FIG. 5 illustrates several examples of welding consumable box-type or crate-type packages 510, 520, and 530. Such packages are typically used to ship bulk welding wire that is coiled into the interior space within the packaging. Such bulk welding wire may weigh 60 pounds or more, with 500 pounds and 1000 pounds not being unusual. The box-type packages may include, for example, several corrugated cardboard corner posts, corrugated cardboard interior surfaces, corrugated cardboard exterior surfaces, and an internal environmental barrier to surround and protect the coiled bulk welding wire. The crate-type packages may include wooden corner posts, wooden side, bottom, and top surfaces, and an internal environmental barrier to surround and protect the coiled bulk welding wire. Furthermore, the packaging may include a pallet (e.g., 511, 521 and 531) that is attached to the bottom portion of a box or crate. The pallet may be made of, for example, wood, corrugated cardboard, or a composite containing both wood, corrugate, and other materials. Such box-type and crate-type packages are typically assembled by the selling entity 200 after acquiring the packaging component parts from one or more supplier entities 220.

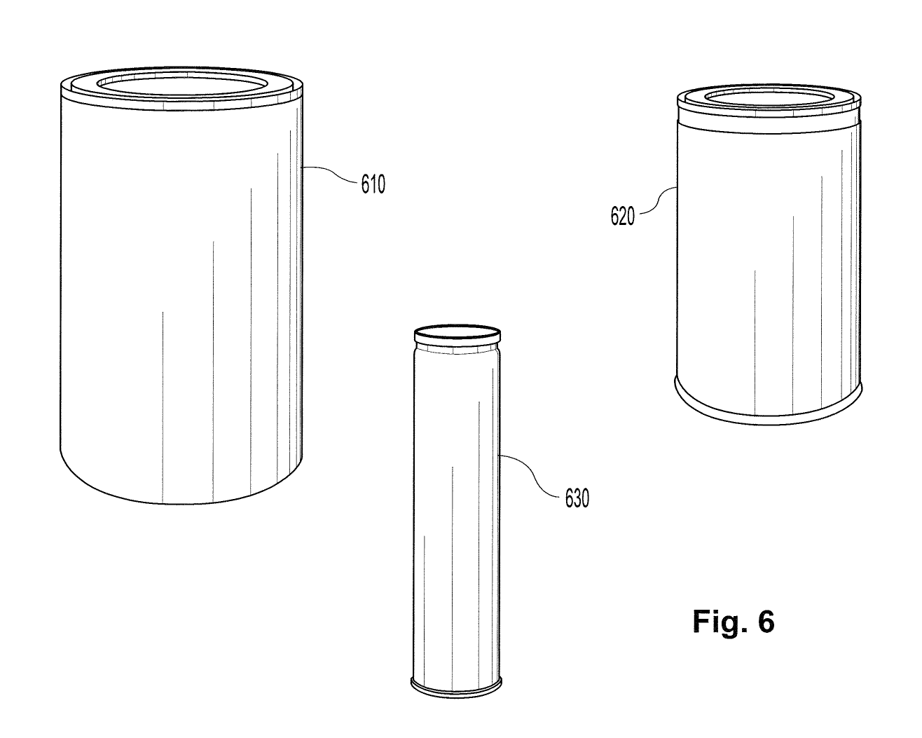

FIG. 6 illustrates several examples of welding consumable drum-type or can-type packages 610, 620, and 630. Such packages are typically used to ship bulk welding wire that is coiled into the interior space within the packaging or stick electrodes that are placed within the packaging. The drum-type packaging may include, for example, a cylindrical cardboard siding with a metal bottom and a metal lid. The can-type packaging may include a cylindrical metal siding with a metal bottom and a plastic lid, for example. The packaging may also include an internal environmental barrier to surround and protect the coiled bulk welding wire or the stick electrodes. Such drum-type and can-type packages are typically assembled by the supplier entity 220 and filled by the selling entity 200.

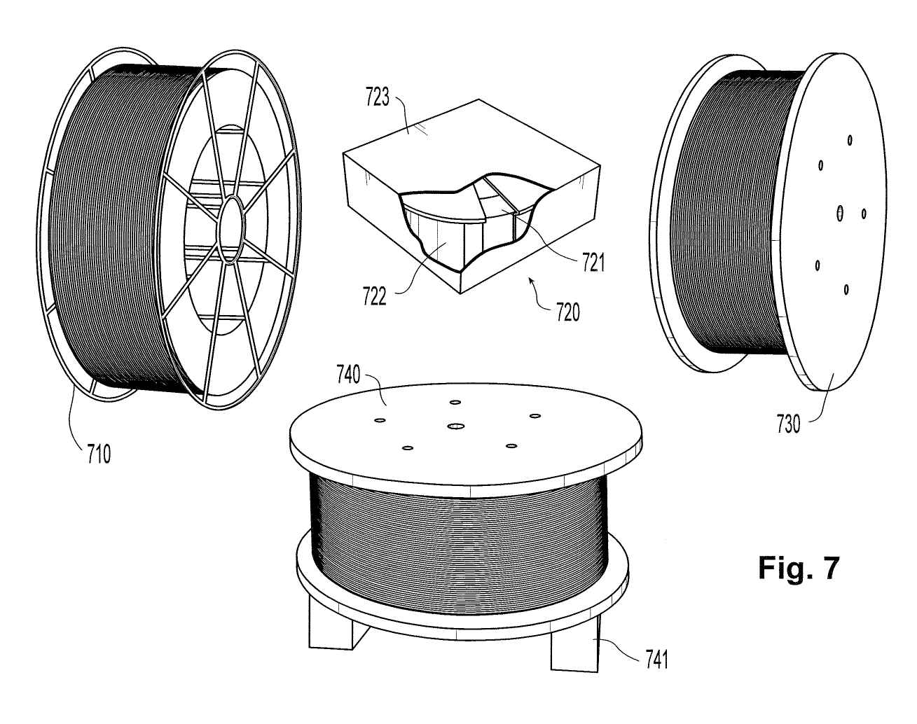

FIG. 7 illustrates several examples of welding consumable reel-type packages 710, 720, 730, and 740 showing the reeled consumable welding wire therewith. Some of the packages of FIG. 7 may also be commonly referred to as coil-type or spool-type packages. The reel-type packaging may include a wooden frame, a plastic frame, or a wire metal frame, for example, around which the consumable welding wire is wound. One version of a reel-type package 720 includes a consumable welding wire reeled onto a plastic frame 721 which is wrapped in a foil environmental barrier 722 and placed in a cardboard box 723. Furthermore, a reel-type packaging 740 may include an integrated skid 742 that is attached to the bottom portion of a frame. The pallet may be made of, for example, wood or corrugated cardboard. The reel-type packaging 710, 730, and 740 are typically manufactured by the supplier entity 220 and filled by the selling entity 200. The packaging components 721, 722, and 723 of the reel-type packaging 720 are typically assembled by the selling entity 200 after acquiring the packaging components from one or more supplier entities 220.

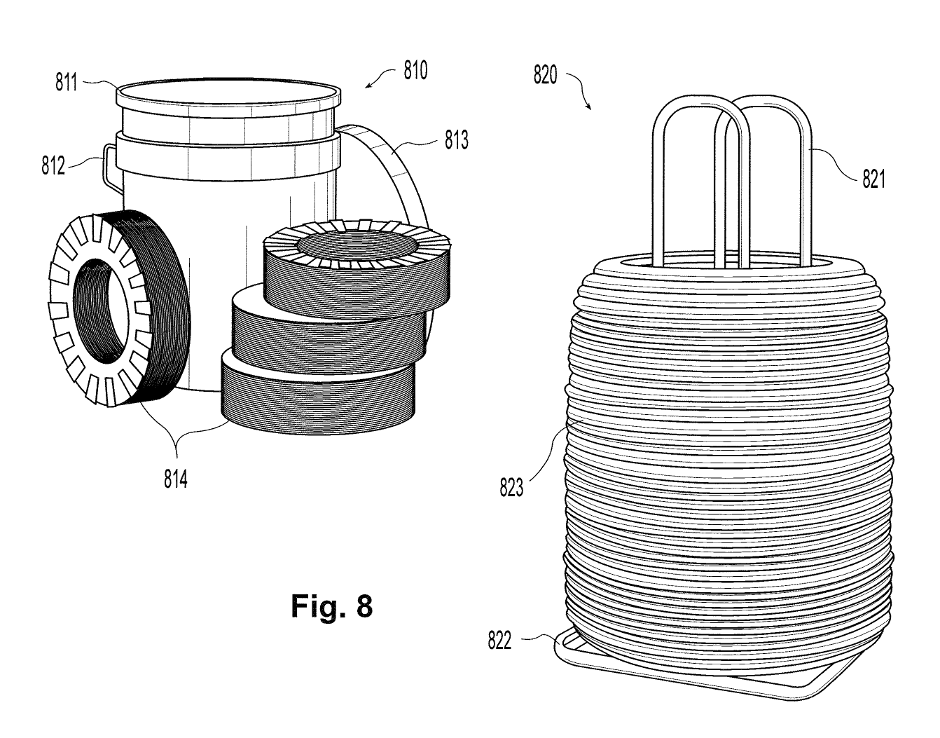

FIG. 8 illustrates an example of a welding consumable pail-type package 810 and an example of a welding consumable stem-type package 820 each showing the consumable welding wire therewith. The pail-type package 810 includes a plastic container 811 having a handle 812 attached thereto and a plastic lid 813 that connects to the top of the container 811. Coils of consumable welding wire 814 may be stacked in the container 811 by the selling entity 200 for transport to a customer entity 210. The stem-type package 820 includes a metal frame stem portion 821, a metal frame base portion 822, and at least one retaining strap 823. A coil of bulk consumable wire is coiled around the metal frame stem portion 821 and held in place by the retaining strap 823 and the base portion 822. The stem-type package 820 may be used for sub-arc welding wire, for example. The packaging components 811, 813, 821, 822, and 823 are typically manufactured and provided by a supplier entity 220 and filled with consumable materials by the selling entity 200.

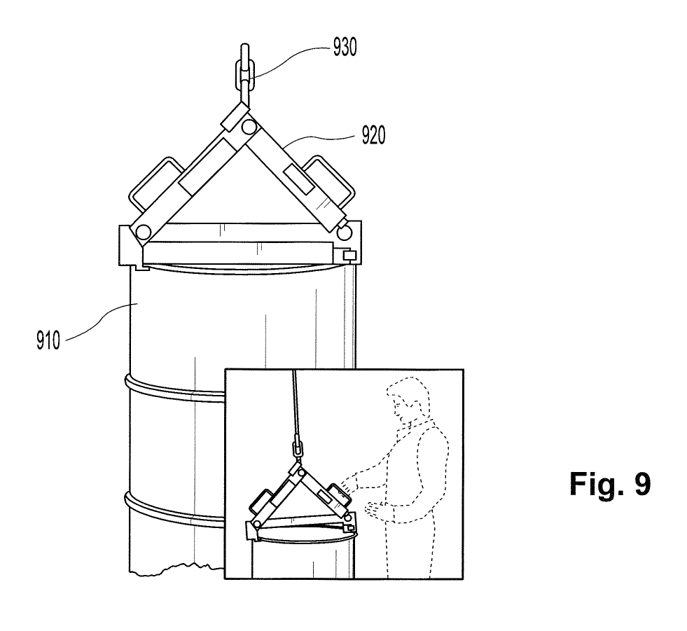

FIG. 9 illustrates an example of how a drum-type package 910 may be lifted, for example, at a customer facility. A grabbing mechanism 920 latches onto a top rim of the package 910. The grabbing mechanism 920 may be attached to a pulley system or a motorized crane via, for example, a chain 930, thus allowing the package 910 to be lifted. Such lifting techniques (a packaging attribute) are eligible for being transformed as part of the method 300 or the method 400 described herein. Other package types (e.g., box types or stem types) may include an integrated lifting strap to facilitate lifting of the package. Such integrated lifting straps (a packaging attribute) are also eligible for being transformed as part of the method 300 or the method 400 described herein.

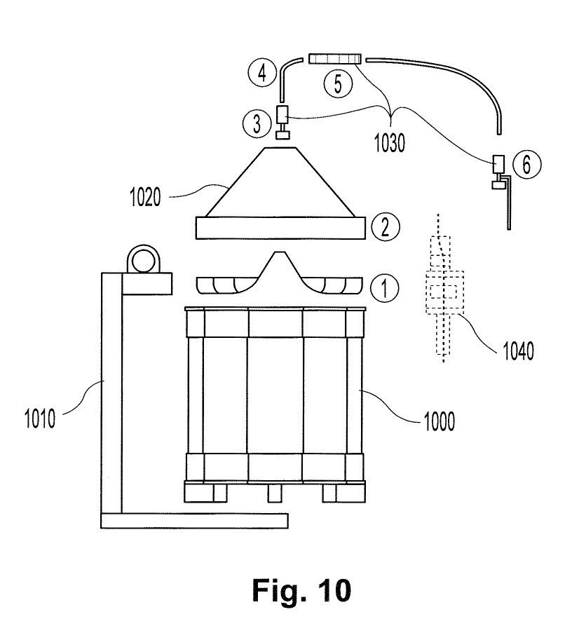

FIG. 10 illustrates a set of instructions that may be printed on a crate-type package 1000, showing how the crate-type package 1000 is to be mounted and set up for use at a customer facility using a mounting frame 1010, a feed cover 1020, various connector parts 1030, and a wire feeder 1040. The indicated instruction steps 1-6 may be associated with corresponding numbered written instructions. Such printed and written instructions (packaging attributes) are eligible for being transformed as part of the method 300 or the method 400 described herein.

FIG. 11 illustrates an embodiment of system components for capturing and analyzing test results, simulating the transformation of packaging attributes, and generating certification documentation.

In summary, methods of testing and certifying a package for transport to a customer and use by a customer, and of correcting packaging failures due to transport and use in the field are disclosed. A package such as, for example, a bulk composite constructed package for shipping welding material product, is tested according to a selected testing protocol. The test results are analyzed and packaging attributes of the package are transformed based on the analyzed test results if the tested package fails any aspect of the testing protocol. Packaging attributes that may be transformed include packaging component design, packaging markings, packaging handling instructions, packaging component manufacturing procedures, packaging component testing procedures, and packaging assembly procedures. Once the package passes all aspects of the testing protocol, customer certification documentation is generated.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A method of correcting packaging failures due to transport and use in the field, said method comprising:
directing a package, having packaging attributes, to be transported to a customer location with certification documentation, wherein said package includes assembled packaging components containing at least one product component;
working with customer personnel to identify any failed packaging components of said package and any damaged product components of said package due to either of transporting said package and handling/using said package at said customer location;
analyzing aspects of said any failed packaging components and said any damaged product components to produce an analysis;
transforming at least one of said packaging attributes of said package based on said analysis to create a transformed package; and
performing a testing and certification process on said transformed package.

2. The method of claim 1 wherein said packaging attributes include at least one of packaging component design, packaging markings, packaging handling instructions, packaging component manufacturing procedures, packaging component testing procedures, and packaging assembly procedures.

3. The method of claim 1 further comprising tracing said any failed packaging components to at least one outside supplier.

4. The method of claim 3 wherein said analysis is produced in coordination with personnel from said at least one outside supplier.

5. The method of claim 1 wherein said analysis is produced in coordination with personnel from said customer.

6. The method of claim 1 further comprising consulting with at least one of internal safety department personnel and internal legal personnel before said transforming at least one of said packaging attributes.

7. The method of claim 1 wherein said step of performing a testing and certification process includes:
selecting a testing protocol;
instructing a third-party to test said transformed package, having packaging attributes, in accordance with the selected testing protocol and to generate corresponding test results;
evaluating the test results to produce an evaluation result;
further transforming at least one of said packaging attributes of said package based on said evaluation result if said package failed any aspect of said testing protocol; and
generating customer certification documentation if said package passed all aspects of said testing protocol.

8. The method of claim 7 wherein said packaging attributes include at least one of packaging component design, packaging markings, packaging handling instructions, packaging component manufacturing procedures, packaging component testing procedures, and packaging assembly procedures.

9. The method of claim 7 wherein said testing protocol is an industrial testing standard.

10. The method of claim 7 wherein said testing protocol is a modification of an industrial testing standard.

11. The method of claim 7 further comprising consulting with at least one of internal safety department personnel and internal legal personnel as part of said selecting a testing protocol.

12. The method of claim 7 further comprising consulting with at least one of internal safety department personnel and internal legal personnel before said further transforming at least one of said packaging attributes.

13. The method of claim 7 further comprising consulting, before said further further transforming at least one of said packaging attributes, with at least one outside supplier of any packaging components of said package that failed said testing protocol.

14. The method of claim 1 wherein said further transforming at least one of said packaging attributes is performed, at least in part, using simulation software running on a computer.

15. The method of claim 1 further comprising isolating or quarantining other packages currently in use or awaiting use by customer personnel which are determined to be suspect due to field performance of other packages from a same batch or identification of a suspect batch via internal quality testing.

16. A system for correcting failures related to packaging, comprising:
a computer configured to receive information relating to one or more failed packaging components of the packaging via a network;
a testing instrumentation configured to produce an analysis of the one or more failed packaging components; and
a simulation software configured to simulate a transformation of the one or more failed packaging components based at least in part on the analysis, wherein the simulation software is executed at least in part on the computer.

17. The system of claim 16, further comprising an analytical database configured to store at least test results related to the packaging.

18. The system of claim 16, wherein the testing instrumentation is configured to re-test at least the transformation of the one or more failed packaging components.

19. The system of claim 16, wherein the computer is configured to trace an outside supplier of the one or more failed packaging components at least in part via the network.

20. A system, comprising:
means for receiving information relating to one or more failed packaging components of the packaging;
means for generating an analysis of the one or more failed packaging components;
means for simulating one or more transformed packaging components related to the one or more failed packaging components;
means for testing the at least one or more transformed packaging components; and
means for storing at least a result of the testing.
